(19) United States
(12) Patent Application Publication
(10) Pub. No.: US 2007/0265989 A1
(43) Pub. Date: Nov. 15, 2007

(54) ARRANGEMENT AND METHOD FOR GENERATION OF A FRANKING IMPRINT

(76) Inventors: Werner Kampert, Hamburg (DE); Dirk Rosenau, Berlin (DE)

Correspondence Address: SCHIFF HARDIN, LLP;PATENT DEPARTMENT, 6600 SEARS TOWER, CHICAGO, IL, 60606-6473, US

(21) Appl. No.: 11/747,350

(22) Filed: May 11, 2007

(30) Foreign Application Priority Data
May 11, 2006 (DE) 10 2006 022 315.2

(51) Int. Cl. G06F 17/00

(52) U.S. Cl. 705/401

(57) ABSTRACT

In a method and an arrangement for generation of a franking imprint, in particular a franking machine, a secure processing unit generates accounting data relevant for the accounting of the generated franking imprint, and a memory device can be connected with the secure processing unit for secured storage of the accounting data. The secure processing unit is arranged in a secure environment that is logically and/or physically secured from undetected, unauthorized access. The memory device is arranged outside of the secure environment. The secure processing unit is fashioned to provide the accounting data in a form secured from undetected manipulation, and the secure processing unit or a further processing unit that can be connected with the secure processing unit is fashioned to write the accounting data provided by the secure processing unit into the memory device in a form secured from undetected manipulation.

### BACKGROUND OF THE INVENTION

1. Field of the Invention

The present invention concerns an arrangement for generation of a franking imprint (in particular a franking machine) of the type having a secure processing unit for generation of accounting (billing) data relevant for charging for the generated franking imprint, and a storage device that can be connected with the secure processing unit for secure storage of the accounting data, the secure processing unit being arranged in an environment logically (electronically) and/or physically secured from unknown, unauthorized access. Furthermore, the invention concerns a corresponding method that can be used in connection with the inventive arrangement.

2. Description of the Prior Art

Franking machines today are normally equipped with a security module that contains the postal register with the accounting data, that effects documents the accounting for the frankings and executes a part of the more or less complex calculations for generation of the respective franking imprint. A number of postal carriers require a portion of the printed data to be cryptographically secured, such that the security module is frequently designed with more or less complexity and is designed as a certified cryptography module.

The scope of services of the franking machine essentially mirrors the scope of services of the security module, not least for reasons of the manufacturing costs. Thus in a franking machine with a small scope of services a security module with only a small scope of services is necessary, while security modules with a greater scope of services (higher computing capacity, higher memory capacity, etc.) are typically used in higher end franking machines.

Specific postal carriers, for example the postal authorities of specific countries, require a very low degree of security of the franking imprint and/or of the accounting data, and thus a clearly lower scope of services of the security module. As a consequence, the security modules typically used for such an application are normally over-dimensioned (over-designed) with regard to their scope of services and thus are too expensive to enable an economical usage of the franking machines.

### SUMMARY OF THE INVENTION

An object of the present invention is to provide an arrangement and a method for generation of a franking imprint of the aforementioned type that do not exhibit the aforementioned disadvantages or exhibit them to a lesser degree, and that enable economical usage of franking machines given lesser postal security requirements.

This object is achieved by an arrangement and a method according to the invention that are based on the insight that an economical usage of franking machines given comparably low postal security requirements is enabled by not storing the accounting data in a specific secured region of the security module, but instead storing the accounting data outside of the security module in a conventional memory region that is not specially secured, but in a form in which the data are secured from undetected manipulation (tampering).

This makes it possible to use security modules designed in a particularly simple manner. These security modules must only still provide the necessary cryptographic functionality, but a large secured, and thus expensive, memory for the accounting data, as is present in the conventional security modules, is no longer required. The designed space for the security module is additionally reduced, such that the expenditure for a possible physical securing of the security module is reduced, and the security module can be fashioned as more compact overall (and thus less vulnerable).

The memory required for the storage of the accounting data can be formed by standard memory modules or the like which are more cost-effective than the typical, especially compact memory components conventionally used for security modules. This memory additionally does not have to be physically protected in an elaborate manner, so the expenditure for the implementation of the storage of the accounting data is distinctly reduced.

In an arrangement for generation of a franking imprint in accordance with the invention, in particular a franking machine with a secure production unit for generation of accounting data relevant for the accounting of the generated franking imprint and with a memory device (which can be connected with the secure processing unit) for secured storage of the accounting data, the secure processing unit is arranged in a secure environment that is logically and/or physically secured from undetected, unauthorized access. According to the invention the memory device is arranged outside of the secure environment. The secure processing unit is therefore fashioned to provide the accounting data in a form secured from undetected manipulation. Furthermore, the secure processing unit, or a further processing unit that can be connected with the secure processing unit, is fashioned to write the accounting data (provided by the secure processing unit) into the memory device in a form secured from undetected manipulation.

Because the accounting data are provided in a form secured from undetected manipulation, a sufficient degree of security can always still be achieved. At any point in time it can be determined (checked) whether the integrity of the stored accounting data exists as before. If, using the accounting data, it can be established that a manipulation of the accounting data has occurred, appropriate responses can follow. It is not absolutely necessary to establish when, by whom and/or to what extent a manipulation was effected in order to achieve a sufficient securing of the postal carrier against attempts to tamper. This is ultimately only a question of the sanctions connected with the detection of a manipulation, such that security of the accounting data that is sufficient for the requirements of specific postal carriers can be achieved with the present invention in a cost-effective manner.

The securing of the accounting data can ensue in any suitable manner. Preferably, provided that the secure processing unit is fashioned to secure the accounting data by cryptographic means from undetected manipulation. For example, a secret item, for example a secret key, can be used in order to generate corresponding security data regarding the accounting data, using which security data the integrity of the accounting data can be traced. This security data can be, for example, a Message Authentication Code (MAC) that is sufficiently well-known, or a digital signature (likewise well-known) or the like that are generated according to any number of known methods.

Digital signatures are advantageously used since these can be verified in a particularly simple manner without knowledge of the secret key (signature key) through the associated public key (verification key) that can be obtained in the framework of a public key infrastructure. The secure processing unit is therefore preferably fashioned to provide the accounting data with a digital signature.

The secure processing unit in principle can be designed in any suitable manner. It can be a component of any type of superordinate physical unit that forms a security module alone or in combination with other physical units. The secure processing unit is preferably a component of a smartcard. A particularly advantageous configuration can be achieved with a smartcard, since such smartcards are already available as prefabricated units with the appropriate cryptographic functionalities. It is then merely required to effect a simple configuration of the smartcard for the appertaining usage case without, however, having to alter the hardware of the smartcard. For example, a logical securing of the security-relevant regions of the smartcard can ensue (insofar as this is not already the case) by implementing, for example, a check of the access authorization to these security-relevant regions. If applicable, an additional physical securing of the smartcard (for example by a sealing compound (potting material) applied to the security-relevant regions of the smartcard (or the entire smartcard) can simply ensue.

The capability of a secure processing unit to reliably determine the real time is an essential aspect in the securing of the accounting data. In preferred variants of the inventive arrangement, the secure processing unit has a time determination unit for determination of the real time. The secure processing unit is advantageously fashioned such that the generation of the accounting data relevant for the accounting of the generated franking imprint ensues only when the time determination unit has successfully determined the real time. Manipulation attempts thus can be reliably countered.

To determine the real time, the secure processing unit can itself include a real time clock. Such real time clocks, however, must be designed in a relatively complex manner in order to exhibit a sufficiently low drift. In particularly cost-effective variants of the inventive arrangement, therefore, the time determination unit is fashioned to effect a synchronization with a real time source at predeterminable points in time, such that a larger imprecision in the determination of the real time can be tolerated, and simple design of the time determination unit is then possible.

The synchronization with the real time source preferably ensues via a secured communication channel in order to preclude tampering. Securing of the communication channel can ensue in any suitable manner, for example by encryption with a secret session key generated beforehand according to an established key generation protocol. Any other known variants for securing communication in the framework of the synchronization of the time determination unit are also suitable.

The synchronization with the real time source can ensue in any suitable manner. For example, the time determination unit can establish a communication with the real time source via a modem or another communication device. It is likewise possible that, in the framework of an existing communication connection between the inventive arrangement and, for example, a remote data center to initiate, a synchronization with the real time source by the data center.

The synchronization with the real time source can furthermore ensue at any suitable points in time. For example, it can ensue in regular, predeterminable intervals. It can likewise ensue upon the occurrence of arbitrary predeterminable events, for example upon activation of the arrangement itself or specific components of the arrangement, upon plugging-in the smartcard, upon every n-th communication (n=1, 2, 3 . . . ) of the arrangement with a remote data center, upon each m-th downloading (m=1, 2, 3 . . . ) of credit, etc.

In a preferred (because it is particularly simple) variant of the inventive arrangement, the time determination unit can be connected with a clock pulse emitter for generation of clock pulses. To determine the current real time, the time determination unit then has a counter for counting the clock pulses of the clock pulse emitter since the last synchronization with the real time source. Given a known clock frequency of the clock pulse emitter the real time then can be determined in a simple manner by counting the clock pulses, starting from the value obtained at the last synchronization.

The clock pulse emitter can be any unit of the inventive arrangement that delivers clock pulses with a stable frequency. It is preferably a clock pulse emitter of the secure processing unit itself, since the risk of manipulations can then thereby be kept to a minimum.

In order to preclude possible manipulations of the time determination unit (and therewith of the real time) by an intermittent stoppage of the clock pulse emitter, the secure processing unit is preferably fashioned such that the generation of the accounting data relevant for the accounting of the generated franking imprint only ensues only when the time determination unit has detected an uninterrupted counting of clock pulses of the clock pulse emitter since the last synchronization with the real time source.

In order to preclude possible manipulations by intermittent (or longer) influences on the clock frequency of the clock pulse emitter, it is furthermore preferable for the time determination unit to be fashioned to monitor the clock frequency of the clock pulses of the clock pulse emitter. The secure processing unit is then fashioned such that the generation of the accounting data relevant for the accounting of the generated franking imprint and/or the generation of the data required for the generation of the franking imprint ensues only when, since the last synchronization with the real time source a variation of the clock frequency, the time determination unit has detected a variation of the clock frequency that lies within a predeterminable tolerance range. In other words, the generating of a franking imprint, or a charge therefor, is prevented when a variation of the clock frequency is detected that lies outside of a predeterminable tolerance range.

In embodiments of the inventive arrangement with the aforementioned further processing unit, the further processing unit can be fashioned for generation of the print data of the franking imprint using a date. The date can either be provided by the arrangement itself and, if applicable, merely be accepted (confirmed) by the user of the arrangement. Alternatively, the user inputs the date. In each case the generation and/or the use of the print data ensues only when the time determination unit has established a predeterminable relationship between the date and a successfully determined current real time. Manipulations of the franking imprint by input or authentication of a false date are thereby precluded in a simple manner.

In a further embodiment of the inventive arrangement it is provided that the secure processing unit can be connected with a remote data center via a communication connection. The secure processing unit is then also fashioned to secure the communication with the remote data center. As explained above, this securing can ensue in any suitable manner. It preferably ensues using cryptographic means such as, for example, a symmetric encryption of the information to be exchanged by means of a previously-generated secret session key. The existing scope of services of the secure processing unit can hereby be optimally utilized in an advantageous manner.

In further preferred embodiments of the inventive arrangement the further processing unit is a component of a printing station for generation of the franking imprint. The further processing unit is in turn connected with an interface of the printing station while the secure processing unit is a component of a security module that can be connected with the interface. The security module is preferably connected in a detachable manner with the interface, such that the security module can preferably be connected with the interface, or can be detached from this at any time without hindrance. A particularly flexible design thus results, since the same printing station can possibly be operated in a simple manner with different security modules. The security module is advantageously fashioned such that it can be plugged in, resulting in a design that is particularly simple and flexible in operation.

As noted above, the securing of the secure processing unit from undetected manipulation can ensue in any suitable manner. Preferably, the secure processing unit is physically secured from undetected, unauthorized access via a physical encapsulation, in particular a sealing compound. Additionally or alternatively the secure processing unit is logically secured in a known manner from undetected, unauthorized access by an algorithm for checking the access rights to the secure processing unit.

The present invention furthermore concerns a method for generation of a franking imprint, in particular by means of a franking machine, wherein a secure processing unit generates accounting data relevant for the accounting of the generated franking imprint and stores the accounting data secured with a memory device that can be connected with the secure processing unit. The secure processing unit is arranged in a safe environment secured logically and/or physically from undetected, unauthorized access. According to the invention, the memory device is arranged outside of the secure environment. The secure processing unit then provides the accounting data in a form secured from undetected manipulation. The secure processing unit or a further processing unit that can be connected with the secure processing unit then writes the accounting data provided by the secure processing unit into a memory device in a form secured from undetected manipulation. The variants and advantages described above can be realized to the same degree with this inventive method.

### DESCRIPTION OF THE DRAWINGS

The single FIGURE schematically illustrates a preferred embodiment of the inventive arrangement for generation of a franking imprint, with which a preferred embodiment of the inventive method for generation of a franking imprint can be implemented.

### DESCRIPTION OF THE PREFERRED EMBODIMENTS

In the following a preferred embodiment of the inventive arrangement in the form of a franking machine 101 for generation of a franking imprint is described with reference to the FIGURE, with which a preferred embodiment of the inventive method for generation of a franking imprint is implemented. The franking machine 101 can be connected via a communication network 102 with a remote data center 103 and comprises a base module 104 and a security module 105 connected with this.

The security module 105 of the franking machine 101 has a secure processing unit in the form of a first processor 105.1 that is arranged in a secure environment 106. The secure environment 106 provides a physical and/or logical securing of the first processor 105.1 from undetected, unauthorized access (tampering). The physical securing of the secure environment 106 is provided by a sealing compound in which the first processor 105.1 as well as the further components is sealed within the secure environment 106.

The logical securing of the secure environment 106 is provided through an algorithm for checking the access authorization to the components of the security module 101. The access to the components of the security module 101 can also ensue from the outside via a first interface 105.2 connected with the first processor 105.1, the first interface 105.2 being arranged at the transition from the secure environment 106 to the region outside of the secure environment.

As soon as access the first processor 105.1 I sought via the first interface 105.2, this first processor 105.1 checks the access authorization of the accessing party. For this purpose, the first processor 105.1 accesses a cryptography module in the form of a memory 105.3 of the security module 101 (which memory 105.3 likewise is arranged in the secure environment 106). The cryptography module 105.3 contains (in a known manner) algorithms and data for verification of the access authorization to the security module. In the simplest case, this can be, for example, a stored password which the accessing party must input in order to be authorized. It can likewise be a suitable algorithm for checking digital signatures or certificates which the accessing party uses in the framework of his authorization.

The security module 101 serves in a typical manner to provide the security-relevant postal services (such as, for example, the secure accounting of the franking values, but also the cryptographic securing of specific postal data) required for the franking.

The base module 104 likewise serves in a typical manner to generate the franking imprint. For this purpose, the base module 104 has a further processing unit in the form of a second processor 14.1 that is connected with a print module 104.2. The second processor 104.1 controls the print module 104.2 in a known manner for generation of the franking imprint on the respective mail piece. For this purpose, the second processor 104.1 accesses, among other things, another postal memory 104.3 of the base module 104 in which is stored a portion of the data (for example cliche data etc.) required for generation of the franking imprint.

In the present example, the second processor 104.1 receives from the security module 105 a further piece of the data required for generation of the franking imprint. These can hereby, for example, be checksums, MACs, digital signatures or the like that the first processor 105.1 of the security module 105 generates about specific data of the franking imprint. In other variants of the invention with lower security requirements for the franking imprint, all data required for generation of the franking imprint are generated exclusively in the base module. In other variants of the invention with higher security requirements for the franking imprint, a majority or even all data required for generation of the franking imprint can be generated in the security module.

When a franking imprint is to be generated, the second processor 104.1 initially transfers input data to the first processor 105.1 via a second interface 104.4 of the base module 104 that is connected with the first interface 105.2 of the security module 105. After the first processor has checked (in the manner already described above) the authorization of the second processor 104.1 to transfer the input data, it processes these input data according to a predetermined scheme.

Among other things, the first processor 105.1 checks (as explained in further detail in the following) whether the input data satisfy certain conditions. If this is the case, the first processor 105.1 generates corresponding output data that it then again transfers to the processor 104.1 via the interfaces 105.2 and 104.4.

Immediately before or after the transfer of the output data to the second processor 104.1, the first processor 105.1 generates accounting data that are used for billing the franking imprint to be generated. However, in a manner different than in conventional franking machines, the accounting data are not stored in an accounting memory within the secure environment 106 but rather are likewise passed to the second processor 104.1 via the interfaces 105.2 and 104.4 and are stored by the second processor 104.1 in an accounting memory 104.5 of the base module 104, consequently thus outside of the secure environment 106.

In order to prevent undetected manipulations of the accounting data, it is inventively provided that the first processor 105.1 provides the accounting data in a form secured from undetected manipulation. In the present example, the first processor 105.1 provides the accounting data with a digital signature that it generates in a sufficiently known manner over at least a portion of the accounting data while accessing the cryptography module 105.3. Other known mechanisms for securing the accounting data from undetected manipulation can also be used in other variants of the invention.

This procedure has the advantage that the security module 105 must merely provide the cryptographic functionality, however not a correspondingly large (and therewith expensively secured) memory region for storage of the accounting data. The security module 105 thus can be designed distinctly more cost-effectively. As in the present example, it is in particular possible to use a simple smartcard for the security module 105, which smartcard is already equipped by default with corresponding cryptographic functionality. With such a smartcard it is then possibly only necessary to produce a physical securing as described above.

The accounting data can be generated in a form which precludes manipulations. For example, a simple manipulation by deletion of individual data sets can be precluded by providing the individual data sets of the accounting data with consecutive numbers that are likewise included in the secured region of the accounting data.

Furthermore, the secured accounting data are stored in the accounting memory 104.5 not only in the course of a franking. Rather, the accounting data in the accounting memory 104.5 naturally also include data representing the current available credit. These data are placed in the accounting memory 104.5 in a download process in the course of a communication between the franking machine 101 and the remote data center 103 via the security module 105. The credit data can already be secured in a corresponding manner by the remote data center 103. However, it is preferable that the credit data transmitted from the data center 103 are initially prepared and secured in the security module 105, and only then are stored in the accounting memory 104.5.

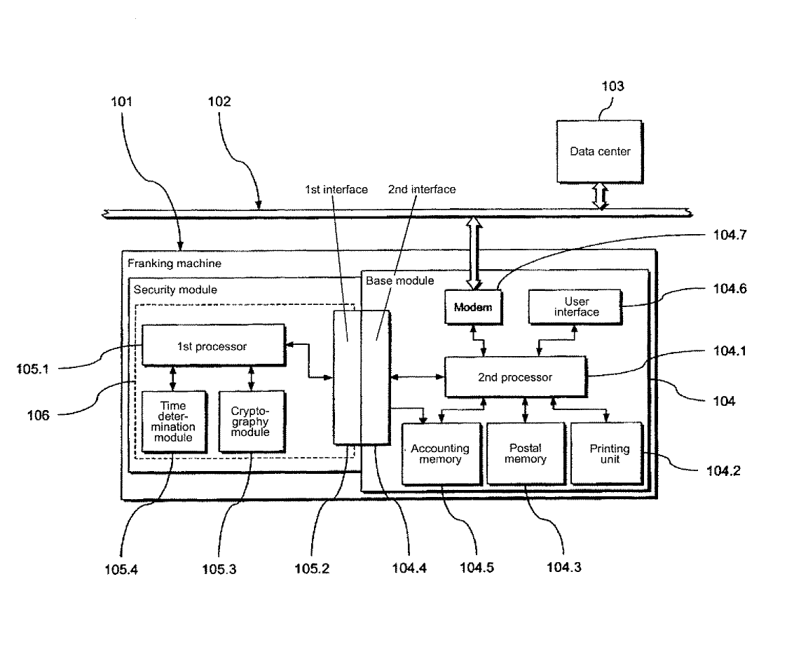

In the present example the correct date of the franking is of significant importance for the security of the accounting process. If a franking imprint should be generated, the second processor 104.1 of the base module 104 thus relays a corresponding date with the input data to the first processor 105.1. This date can be provided by default by a clock (not shown in FIG. 1) of the base module 104. It is also possible to require the user of the franking machine 101 to confirm this date. Another alternative is for the user of the franking machine 101 to enter the date via a user interface 104.6 (for example a keyboard) into the second processor 104.1, this then being the date that is used.

As described above, in the present example the security module 105 checks whether the delivered date is in the past. If this is the case, the security module effects neither the generation of the data required for the creation of the franking imprint nor the generation of the corresponding accounting data. In other words, these data are only generated when the delivered date corresponds to the current date in the security module 105 or represents a date in the future. The maximum time span at which the data may be delivered in the future may be limited.

In order to be able to conduct this check of the data delivered by the second processor 104.1, the security module 105 has a time determination unit in the form of a time determination module 105. which determines the real time independent of the base module 104.

For this the time determination module 105.4 initially synchronizes with a real time source of the remote data center 103 upon occurrence of predetermined events. The events which initiate the synchronization with the real time source can be arbitrarily predetermined. For example, it can thus be provided that the synchronization ensues every time the franking machine 101 has successfully established a communication with the remote data center 103 by means of a modem 104.7 connected with the second processor 104.1. Such a communication with the remote data center 103 can be required or automatically initiated by the security module 105 after the expiration of a predetermined time span since the last synchronization of the time determination module 105.4 with the real time source of the remote data center 103.

In order to counter manipulations in the synchronization with the real time source, the communication with the data center 103 within which the synchronization ensues is correspondingly secured in a sufficiently known manner by the first processor 105.1 through access to the cryptography module 105.3, for example via use of an encryption of the exchanged data with a secret session key.

As soon as the time determination module 105.4 has obtained the current real time in the framework of the synchronization with the real time source of the remote data center 103, the time determination module 105.4 begins with the counting of the clock pulses of a clock pulse emitter of the first processor 105.1. Among other things, the time determination module 105.4 also monitors the clock frequency of the clock pulse emitter as to whether deviations of the clock frequency from a desired clock frequency lie within a specific tolerance range. Furthermore, the time determination module 105.4 monitors the non-interrupted pulsing of the clock pulse emitter. In other words, the time determination module 105.4 thus monitors whether an intermittent cessation of the pulsing of the clock pulse emitter occurs.

If the clock frequency of the clock pulse emitter lies within the predetermined tolerance range and if a gapless pulsing exists since the last synchronization with the real time source, the time determination module 105.4 determines the current real time from the real time delivered with the last synchronization, the number of the clock pulses and the clock frequency of the clock pulse emitter. If these requirements are not present, it is established that no correct real time is to be determined and the implementation of further operations in connection with the generation of a franking imprint is refused. In this case a corresponding error message can be output to the user of the franking machine 101 or a new synchronization with the real time source can possibly be forced.

A sufficiently reliable determination of the real time can ensue in a particularly simple manner with the described time determination module 105.4. In other variants of the invention, the security module can include a real time clock that enables the real time determination.

If the time determination module 105.4 successfully determines the real time, it compares this with the delivered date. If the delivered date corresponds to the requirements illustrated above, the first processor 105.1 generates the data required for the generation of the franking imprint in the manner described above as well as the accounting data and passes these to the second processor 104.1 for further processing. Otherwise, the first processor 105.1 refuses the implementation of further operations in connection with the generation and accounting of the franking imprint. In particular neither the data required for the generation of the franking imprint nor corresponding accounting data are generated.

The cryptographic service features of the security module 105 can still be used by the franking machine 101 in a further scope. The security module 105 can naturally secure not only the communication during the synchronization with the real time source of the remote data center 103. Such securing can also ensue in the described manner for any arbitrary other communications between the franking machine and an external unit, for example the remote data center 103 upon downloading of credit or a service computer of a service technician etc. Furthermore, the security module 105 naturally can be used in a known manner to verify the integrity and authenticity of specific transmitted data or even to provide for a corresponding authentication. The security module 105 can be used, for example, in order to verify or, respectively, to create digital signatures or similarly acting data.

As mentioned above, in the present example the security module 105 is executed as a simple smartcard that is additionally provided further with a physical securing in the form of a sealing compound in which the components of the security module are embedded. In other variants of the invention, only the security-relevant parts of such a smartcard that are to be arranged in a secure environment are provided with a physical encapsulation, while other regions are more or less freely accessible. In this case it is then only necessary to ensure that a logical securing is active for all possible accesses to the security-relevant components.

In the present example the security module 105 is a simple plug card that is plugged into a second interface 104.4. The second interface 104.4 can thereby be freely accessible, such that any security modules 105 can be plugged in without further measures. This has the advantage that the base module 104 can possibly be freely operated in connection with a plurality of different security modules.

In particular, it is possible to use the franking machine 101 with the security modules of different postal carriers. In this case it is possible for the security module 105 to store in a corresponding memory, the specifications (for example algorithms and data, etc.) according to which the franking imprint is to be generated for the appertaining postal carriers.

If this is the case, a separate region of the accounting memory 104.5 is preferably provided for each security module. Additionally or alternatively, the accounting data in this case can, in their secured range include a unique identification of the respective security module from which they were generated, this unique identification being stored to simplify the association with the respective security module. Given one series of securing mechanisms this association is already possible anyway since the secret data used for securing (for example signature keys etc.) are unambiguously associated with a single security module anyway.

In other variants of the invention the security module is fashioned as a fixed, integrated component of the franking machine.

The memory of the security module 105 or of the base module 104 described in the preceding can be fashioned entirely or in part as separate memory modules or as individual memory regions of a single memory module.

Although modifications and changes may be suggested by those skilled in the art, it is the intention of the inventors to embody within the patent warranted hereon all changes and modifications as reasonably and properly come within the scope of their contribution to the art.

We claim as our invention:

1. An arrangement for generating a franking imprint comprising:
a plurality of components that, in combination, generate and print a franking imprint;
a secure environment that is protected against unauthorized access to an interior of said secure environment, said secure environment being an environment selected from the group consisting of a logically electronically protected environment and a physically protected environment, said plurality of components being located outside of said secure environment;
a secure processing unit, located inside said secure environment, that generates accounting data representing a monetary charge associated with the generated franking imprint;
a memory device, located outside of said secure environment, in which said accounting data are stored in a secured manner; and
said secure processing unit generating said accounting data in a form secured from tampering and causing said accounting data to be written, in said form secured from tampering, into said memory device.

2. An arrangement as claimed in claim 1 wherein said secure processing unit writes said accounting data directly from said secure processing unit into said memory device only through an interface arrangement interfacing said secure environment with said memory device.

3. An arrangement as claimed in claim 1 wherein said plurality of components for generating and printing said franking imprint include a further processing unit, outside of said secure environment, and wherein said secure processor is in communication with said further processing unit through an interface arrangement, interfacing said secure environment with said further processing unit, and wherein said further processing unit is connected to said accounting memory, and wherein said secure processing unit writes said accounting data into said memory device through said interface arrangement and through said further processing unit.

4. An arrangement as claimed in claim 3 wherein said further processing unit generates print data representing said franking imprint.

5. An arrangement as claimed in claim 4 comprising a time determination unit located in said secure environment that determines real time, said time determination unit being connected to said secure processing unit and being in communication with said further processing unit through said secure processing unit and said interface arrangement, and wherein said further processing unit generates said print data using a date, and generates or releases said print data only when a predetermined relationship exists between said date and said real time.

6. An arrangement as claimed in claim 5 comprising a user interface allowing manual entry of said date into said further processing unit.

7. An arrangement as claimed in claim 1 wherein said secure processing unit cryptographically secures said accounting data from unauthorized access.

8. An arrangement as claimed in claim 1 wherein said secure processing unit secures said accounting data from unauthorized access by using a digital signature.

9. An arrangement as claimed in claim 1 comprising a smartcard, and wherein said secure environment is at least a portion of said smartcard and wherein said secure processing unit is a component in said portion of said smartcard.

10. An arrangement as claimed in claim 1 comprising a time determination unit, located in said secure environment and connected therein to said secure processing unit, said time determination unit determining real time and said secure processing unit generating said accounting data dependent on said real time.

11. An arrangement as claimed in claim 10 wherein said secure processing unit identifies if and when said time determination unit has successfully determined said real time, and wherein said secure processing unit generates said accounting data only after said time determination unit has successfully determined said real time.

12. An arrangement as claimed in claim 11 wherein said secure processing unit has access to a real time source through said interface arrangement and uses a real time signal from said real time source to identify when said time determination unit has successfully determined said real time.

13. An arrangement as claimed in claim 12 comprising a clock pulse emitter, located in said secure environment, that generates clock pulses and supplies said clock pulses to said time determination unit, and wherein said time determination unit comprises a counter that determines said real time by counting clock pulses emitted by said clock pulse emitter since a last synchronization with said real time signal from said real time source.

14. An arrangement as claimed in claim 13 wherein said secure processing unit generates said accounting data only when said time determination unit has detected an uninterrupted counting of said clock pulses emitted by said clock pulse emitter since said last synchronization.

15. An arrangement as claimed in claim 13 wherein said clock pulse emitter emits said clock pulses at a clock frequency, and wherein said time determination unit monitors said clock frequency and communicates a monitoring result to said secure processing unit, and wherein said secure processing unit generates said accounting data only when, since said last synchronization, any variation of said clock frequency monitored by said time determination unit, and included in said monitoring result, is within a predetermined tolerance range.

16. An arrangement as claimed in claim 1 comprising a communication connection configured to connect said secure processing unit, through said interface arrangement, with a remote data center, said secure processing unit communicating, in a communication, with said remote data center and cryptographically securing said communication with said remote data center.

17. An arrangement as claimed in claim 1 wherein said secure environment is a franking machine security module.

18. An arrangement as claimed in claim 17 wherein said security module is a plug-in component.

19. An arrangement as claimed in claim 1 wherein said secure environment is an electronically logically secured environment secured by an algorithm that is executed by said secure processing unit.

20. An arrangement as claimed in claim 1 wherein said secure environment is a physically secured environment, comprising a physical encapsulation in which said secure processing unit is contained.

21. A method for generating a franking imprint comprising the steps of:
with a plurality of components operating, in combination, generating and printing a franking imprint;
protecting a secure environment against unauthorized access to an interior of said secure environment, said by protection selected from the group consisting of logical electronic protection and physical protection, said plurality of components being located outside of said secure environment;
locating a secure processing unit inside said secure environment and, in said secure processing unit, generating accounting data representing a monetary charge associated with the generated franking imprint;
locating a memory device outside of said secure environment, and storing accounting data in a secured manner in said memory device by, in said secure processing unit, generating said accounting data in a form secured from tampering and causing said accounting data to be written, in said form secured from tampering, into said memory device.

22. A method as claimed in claim 21 comprising writing said accounting data directly from said secure processing unit into said memory device only through an interface arrangement interfacing said secure environment with said memory device.

23. A method as claimed in claim 21 wherein said plurality of components for generating and printing said franking imprint include a further processing unit, outside of said secure environment, and comprising placing said secure processor in communication with said further processing unit through an interface arrangement, that interfaces said secure environment with said further processing unit, and wherein said further processing unit is connected to said accounting memory, and comprising writing said accounting data into said memory device from said secure processing unit through said interface arrangement and through said further processing unit.

24. A method as claimed in claim 23 comprising generating print data in said further processing unit representing said franking imprint.

25. A method as claimed in claim 24 comprising determining real time in a time determination unit located in said secure environment, said time determination unit being connected to said secure processing unit and being in communication with said further processing unit through said secure processing unit and said interface arrangement, and comprising in said further processing unit, generating said print data using a date, and generating or releasing said print data only when a predetermined relationship exists between said date and said real time.

26. A method as claimed in claim 21 comprising manually entering said date into said further processing unit.

27. A method as claimed in claim 21 comprising in said secure processing unit, cryptographically securing said accounting data from unauthorized access.

28. A method as claimed in claim 21 comprising, in said secure processing unit, securing said accounting data from unauthorized access using a digital signature.

29. A method as claimed in claim 21 comprising forming said secure environment as at least a portion of a smartcard and making said secure processing unit a component in said portion of said smartcard.

30. A method as claimed in claim 21 comprising locating a time determination unit in said secure environment and connecting said time determination unit therein to said secure processing unit and, in said time determination unit determining real time and said secure processing unit generating said accounting data dependent on said real time.

31. A method as claimed in claim 30 comprising, in said secure processing unit identifying if and when said time determination unit has successfully determined said real time, and generating said accounting data only after said time determination unit has successfully determined said real time.

32. A method as claimed in claim 31 comprising providing said secure processing unit with access to a real time source through said interface arrangement and, in said secure processing unit, using a real time signal from said real time source to identify when said time determination unit has successfully determined said real time.

33. A method as claimed in claim 32 comprising locating a clock pulse emitter in said secure environment and generating clock in said clock pulse emitter pulses and supplying said clock pulses to said time determination unit comprising and, in a counter in said time determination unit, determining said real time by counting clock pulses emitted by said clock pulse emitter since a last synchronization with said real time signal from said real time source.

34. A method as claimed in claim 33 comprising generating said accounting data in said secure processing unit only when said time determination unit has detected an uninterrupted counting of said clock pulses emitted by said clock pulse emitter since said last synchronization.

35. A method as claimed in claim 31 wherein said clock pulse emitter emits said clock pulses at a clock frequency and comprising, in said time determination unit, monitoring said clock frequency and communicates a monitoring result to said secure processing unit and, in said secure processing unit, generating said accounting data only when, since said last synchronization, any variation of said clock frequency monitored by said time determination unit, and included in said monitoring result, is within a predetermined tolerance range.

36. A method as claimed in claim 21 comprising establishing a communication connection between said secure processing unit, through said interface arrangement, and a remote data center, said secure processing unit communicating, in a communication, with said remote data center and cryptographically securing said communication with said remote data center.

37. A method as claimed in claim 21 comprising establishing said secure environment in a franking machine security module.

38. A method as claimed in claim 37 employing a plug-in component as said security module.

39. A method as claimed in claim 21 comprising establishing said secure environment as an electronically logically secured environment secured by an algorithm that is executed by said secure processing unit.

40. A method as claimed in claim 21 comprising establishing said secure environment as a physically secured environment by physically encapsulating said secure processing unit.
